(19) United States
(12) Patent Application Publication
(10) Pub. No.: US 2016/0087673 A1
(43) Pub. Date: Mar. 24, 2016

(54) CANCELLATION CIRCUITS AND TRANSCEIVER CIRCUITS TO SUPPRESS INTERFERENCE

(71) Applicant: HON HAI PRECISION INDUSTRY CO., LTD., New Taipei (TW)

(72) Inventor: KWO-JYR WONG, New Taipei (TW)

(21) Appl. No.: 14/830,099

(22) Filed: Aug. 19, 2015

(30) Foreign Application Priority Data
Sep. 24, 2014 (TW) 103133118

(51) Int. Cl. H04B 1/44; H04B 15/04; H01P 1/20; H01P 5/16; H01P 1/18

(52) U.S. Cl. CPC H04B 1/44; H01P 5/16; H01P 1/18; H01P 1/20; H04B 15/04

(57) ABSTRACT

An interference-cancelling circuit includes a main delay line, a first power divider, a first power combiner, and first circuits. The main delay line delays a number of transmitting signals. The first power divider is coupled to the main delay line. Each of the first circuits including n branch circuits is configured to generate cancellation signals for canceling leakage signals (where “n” is an integer of 2 or more). A first branch circuit of the n branch circuits is coupled between the first power divider and the first power combiner. A (k−1)-th branch circuit of the n branch circuits is coupled to a k-th branch circuit of the n branch circuits (where “k” is an integer from 2 to n). The first power combiner outputs cancellation signals generated by the first circuit. A transceiver circuit is also provided.

### FIELD

The subject matter herein generally relates to wireless communication fields, and more particularly relates to cancellation circuits and transceiver circuits for suppressing interference.

### BACKGROUND

Wireless transceiver systems usually include receiver circuits and transmitter circuits. A circulator is usually used as an isolation element between the receiver circuits and the transmitter circuits. However, the isolation provided by the circulator may be insufficient. Thus, the transmitted signals may leak to the receiver circuits and influence the received signals. In addition, the received signals may be interfered with by signals reflected from short-range obstacles. Therefore, the signal-receiving ability of the receiver circuits is less than optimal.

### BRIEF DESCRIPTION OF THE DRAWINGS

Implementations of the present technology will now be described, by way of example only, with reference to the attached figures, wherein:

FIG. 1 is a functional block diagram of the transceiver circuit according to an embodiment of the disclosure;

FIG. 2 is a functional block diagram of the cancellation circuit according to a first embodiment of the disclosure;

FIG. 3 is a functional block diagram of the cancellation circuit according to a second embodiment of the disclosure;

FIG. 4 is a functional block diagram of each branch circuit of the first circuit according to an embodiment of the disclosure;

FIG. 5 is a functional block diagram of the second circuit according to an embodiment of the disclosure;

FIG. 6 is a functional block diagram of each branch circuit of the third circuit according to an embodiment of the disclosure;

FIG. 7 is a functional block diagram of each branch circuit of the fourth circuit according to an embodiment of the disclosure;

FIG. 8 is a functional block diagram of the cancellation circuit according to a third embodiment of the disclosure;

FIG. 9 is a functional block diagram of the first unit and the second unit according to an embodiment of the disclosure;

FIG. 10 is a circuit diagram of the matching circuit according to an embodiment of the disclosure;

FIG. 11 illustrates the delay of branch circuits of the cancellation circuit according to an embodiment of the disclosure; and

FIG. 12 illustrates the delay of branch circuits of the cancellation circuit according to another embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

In the described embodiments, the direction of the arrow indicates the path of a signal, from an input terminal to an output terminal.

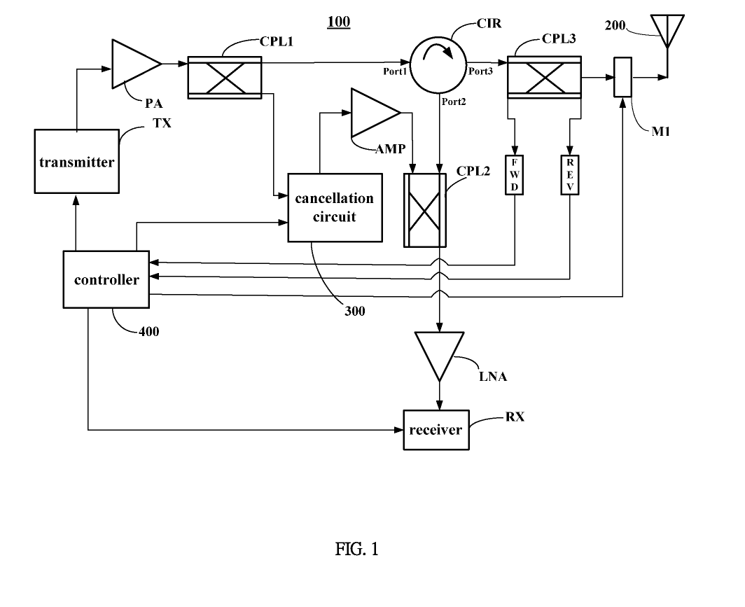

FIG. 1 illustrates a transceiver circuit 100 according to an embodiment of the disclosure. In the embodiment, the transceiver circuit 100 may comprise a transmitter TX, a receiver RX, a first amplifier PA, a second amplifier LNA, a third amplifier AMP, a circulator CIR, a first coupler CPL1, a second coupler CPL2, a third coupler CPL3, an antenna 200, and a cancellation circuit 300.

The transmitter TX is coupled to a first port (Port1) of the circulator CIR through the first amplifier PA and the first coupler CPL1 in sequence. A second port (Port2) of the circulator CIR is coupled to the receiver RX through the second coupler CPL2 and the second amplifier LNA in sequence. A third port (Port3) of the circulator CIR is coupled to the antenna 200 through the third coupler CPL3 and the matching circuit M1. The transmitter TX is configured to transmit signals. Signals in the course of being transmitted and transmitted signals are hereinafter referenced as “transmitting signals.” The first amplifier PA is configured to amplify the transmitting signals. The receiver RX is configured to obtain the received signals, which are being processed by interference cancellation. Signals in the course of being received and received signals are hereinafter referenced as “receiving signals.” The second amplifier LNA is configured to amplify the receiving signals. The circulator CIR can be a three-port circulator, configured to isolate the transmitting signals and the receiving signals of the transceiver circuit 100. The matching circuit M1 is configured to match the internal impedance of the transceiver circuit 100. The first coupler CPL1, the second coupler CPL2 and the third coupler CPL3 are each coupled to a different port of the circulator CIR to match the impedances of the input and output of the circulator CIR.

In the embodiment, two types of interference signals for the receiver RX are therein decreased. One is leakage signals. In FIG. 1, leakage signals are transmitted to the second coupler CPL2 through the transmitter TX and the circulator CIR, such that the receiver RX may be interfered with by the leakage signals. The other one is near-field interference signals. The transmitting signals transmitted by the transmitter TX radiate from the antenna 200, and may be reflected by short-range obstacles. The reflected signals may be transmitted to the second coupler CPL2 through the circulator CIR, such that the receiver RX may be interfered with by the reflected signals.

The cancellation circuit 300 and the third amplifier AMP are coupled between the first coupler CPL1 and the second coupler CPL2. The cancellation circuit 300 is configured to generate cancellation signals to suppress the interference in the receiving signal caused by the leakage signals and the near-field interference signals. Here, the first coupler CPL1 transmits a number of transmitting signals of the transmitter TX to the cancellation circuit 300. The third amplifier AMP is configured to amplify the cancellation signals to increase the quantity of cancellation signals which couple to the second coupler CPL2. That is, the coupling coefficients of the cancellation signals are increased. Thus, the main-line insertion loss of the second coupler CPL2 is minimized to decrease the influence of the second coupler CPL2 on the receiving signals in terms of noise, improving the sensitivity of the receiver RX.

In other embodiments, the transceiver circuit 100 may comprise a forward power detector FWD, a reverse power detector REV, a matching circuit M1, and a controller 400. The forward power detector FWD and the reverse power detector REV are coupled to the third coupler CPL3, and respectively obtain the magnitude of transmission power of the transceiver circuit 100 and the magnitude of reverse power reflected from the antenna 200. The controller 400 is coupled to the transmitter TX, the receiver RX, the forward power detector FWD, the reverse power detector REV, the matching circuit M1, and the cancellation circuit 300. The controller 400 is configured to adjust the input voltage of the matching circuit M1 to improve the impedance matching between the transceiver circuit 100 and the antenna 200. The controller 400 further controls the signal strength and frequency output by the transmitter TX, and, to evaluate the result of the interference suppression, obtains the receiving signals after interference suppression. In addition, the controller 400 further adjusts the parameters of the cancellation circuit 300 according to the result of the interference suppression to optimize the function of the interference suppression.

In the embodiments, the power divider may comprise an input terminal and two output terminals, and the power combiner may comprise two input terminals and one output terminal.

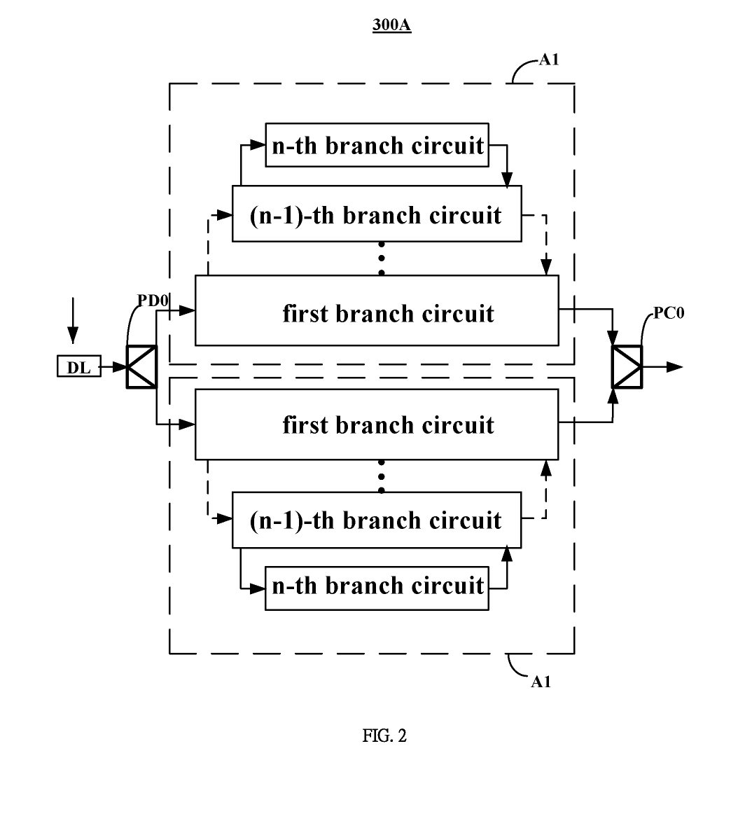

FIG. 2 illustrates a cancellation circuit 300A according to a first embodiment of the disclosure. In the first embodiment, the cancellation circuit 300A may comprise a main delay line DL, a plurality of first circuits A1, a first power divider PD0, and a first power combiner PC0. The input of the main delay line DL is the input of the cancellation circuit 300A. The main delay line DL is coupled to the first coupler CPL1 to obtain a number of the transmitting signals, and the obtained transmitting signals are delayed. The first circuit A1 is configured to generate the cancellation signals for canceling the leakage signals according to the delayed transmitting signals. The first circuit A1 may comprise n branch circuits (where “n” is an integer). The output of the main delay line DL is coupled to the first power combiner PC0, two first branch circuits of the n branch circuits, and two input terminals of the first power combiner PC0. The first power combiner PC0 outputs the cancellation signals generated by the plurality of first circuits A1. The first branch circuit is coupled to the second branch circuit, and the second branch circuit is coupled to the third branch circuit. In this manner, the (k−1)-th branch circuit is coupled to the k-th branch circuit to form the n branch circuits (where 2≦k≦n, and “n” and “k” are integers). The n branch circuits are configured to generate the cancellation signals for canceling the leakage signals. The delay and amplitude of the signals are changed after passing through the first circuits A1, and the signals are output from the first power combiner PC0. In other embodiments, a first circuit A1 may be coupled between each output terminal of the first power divider PD0 and each input terminal of the first power combiner PC0 when the first power combiner PC0 comprises more than two output terminals and the first power divider PD0 comprises more than two input terminals.

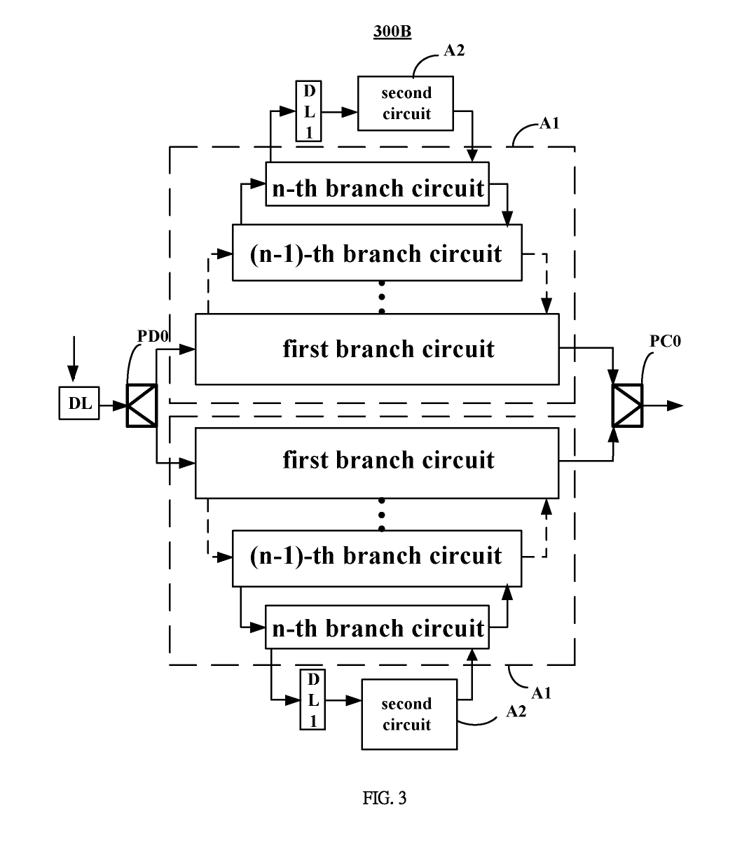

FIG. 3 illustrates the cancellation circuit 300B according to a second embodiment of the disclosure. In the second embodiment, the cancellation circuit 300B comprises the main delay line DL, the first circuits A1, the first power divider PD0, and the first power combiner PC0 in the first embodiment, and further comprises a plurality of first delay lines DL1 and a plurality of second circuits A2. The n-th branch circuit of the first circuit A1 is coupled to the first delay line DL1 and the second circuit A2 to generate the cancellation signals for canceling the near-field interference signals. The delay and amplitude of the signals are changed after passing through the first delay lines DL1 and the second circuits A2, and the signal is output from the first power combiner PC0.

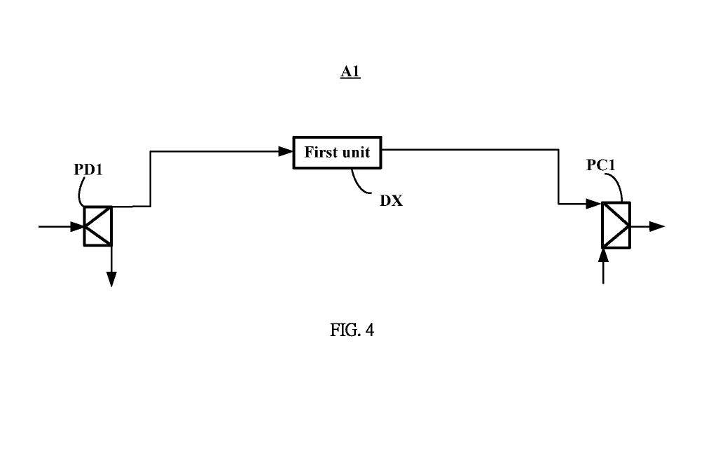

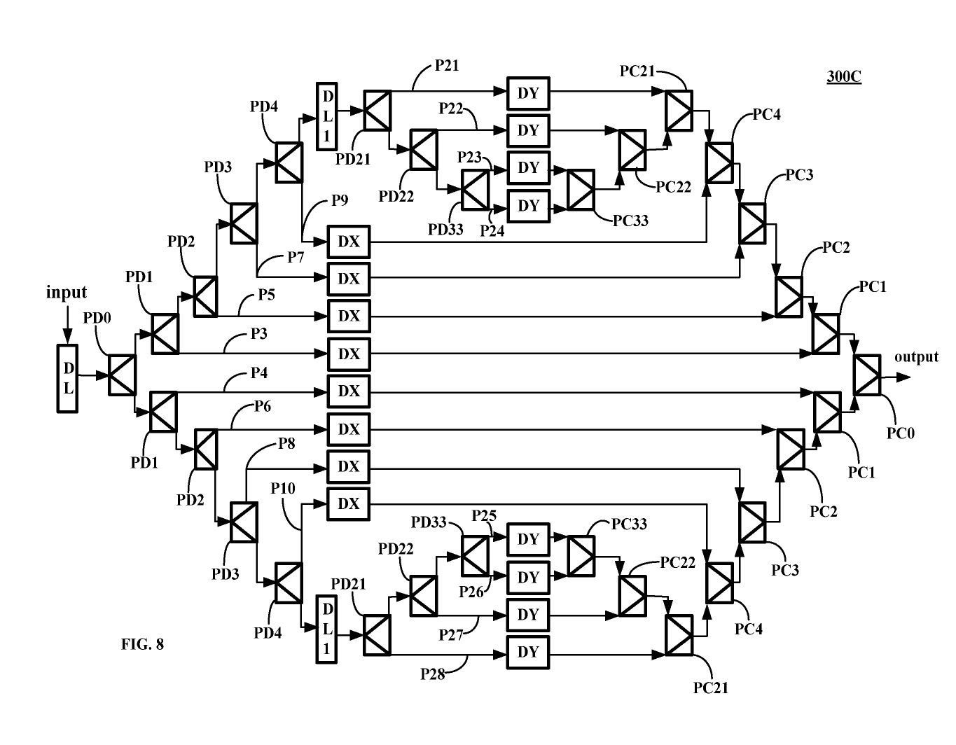

FIG. 4 illustrates each branch circuit of the first circuit A1 according to an embodiment of the disclosure. In the embodiment, each branch circuit may comprise a second power divider PD1, a first unit DX, and a second power combiner PC1. The input of the second power divider PD1 is the input of each branch circuit. The first output terminal of the second power divider PD1 is coupled to the first input terminal of the second power combiner PC1 through the first unit DX. The output of the second power combiner PC1 is the output of each branch circuit. The first unit DX adjusts the delay and amplitude of the signals passing through each branch circuit. The detail structure of the first unit DX is shown in FIG. 8.

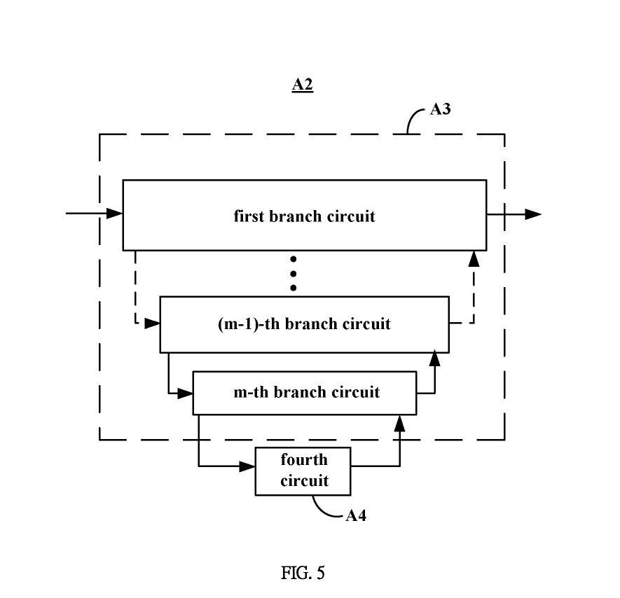

FIG. 5 illustrates a second circuit A2 according to an embodiment of the disclosure. In the embodiment, the second circuit A2 may comprise a third circuit A3 and a fourth circuit A4. In the embodiment, the second circuit A2 may comprise m branch circuits (where “m” is an integer) and the h-th branch circuit is coupled to the (h−1)th branch circuit (2≦h≦m, and “m” and “h” are integers). In addition, the m-th branch circuit is coupled to the fourth circuit A4. The delay and amplitude of the signals are changed after passing through the second circuit A2.

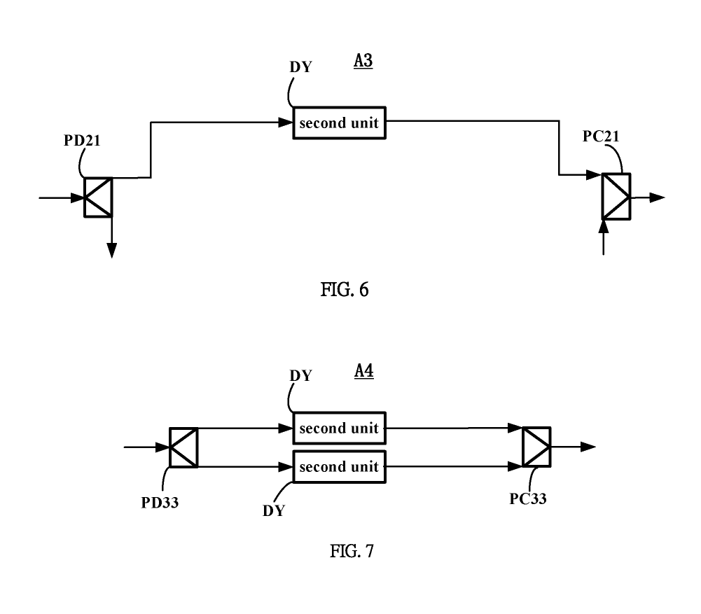

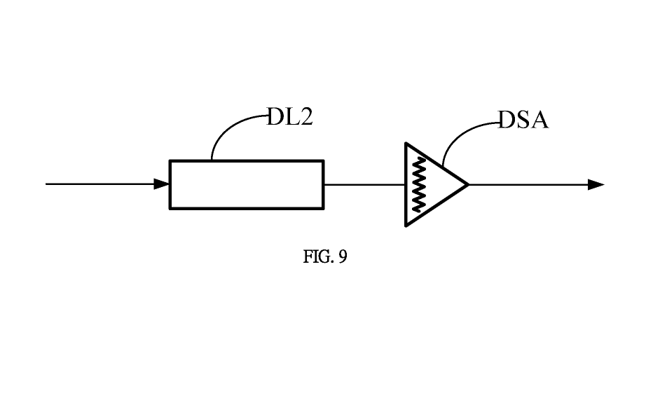

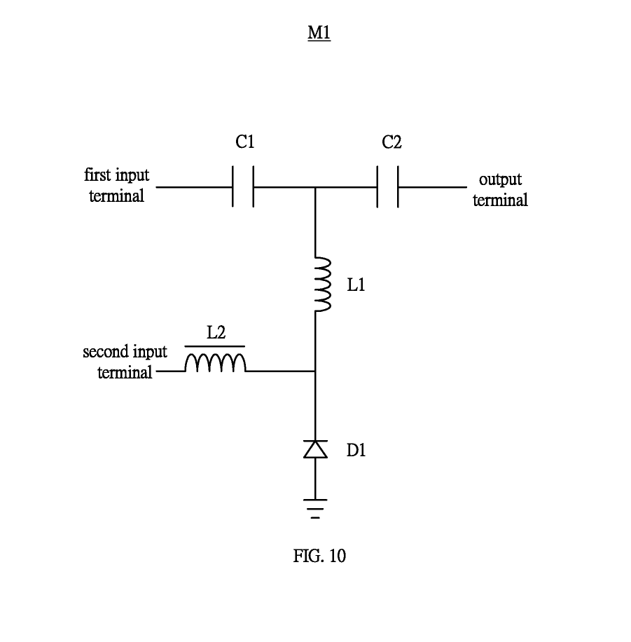

FIG. 6 illustrates a branch circuit of the third circuit A3 according to an embodiment of the disclosure. FIG. 7 illustrates a branch circuit of the fourth circuit A4 according to an embodiment of the disclosure. In the embodiment, each branch circuit of the third circuit A3 may comprise a third power divider PD21, a second unit DY, and a third power combiner PC21. The first output terminal of the third power divider PD21 is coupled to the first input terminal of the third power combiner PC21 through the second unit DY. The fourth circuit A4 may comprise a fourth power divider PD33, two second units DY, and a fourth power combiner PC33. The two output terminals of the fourth power divider PD33 are coupled to the two input terminals of the fourth power combiner PC33 through the second units DY. The second unit DY adjusts the delay and amplitude of the signals passing through the third circuit A3 or the fourth circuit A4. The detail structure of the second unit DY is shown in FIG. 9.

FIG. 8 illustrates a cancellation circuit 300C according to a third embodiment of the disclosure. Referring to FIG. 2-FIG. 8, in the third embodiment, the cancellation circuit 300C comprises the main delay line DL, a plurality of first delay lines DL1, a plurality of first circuits A1, and a second module. The input of the main delay line DL is the input the cancellation circuit 300C. The main delay line DL is coupled to the first coupler CPL1 to obtain a number of the transmitting signals. The cancellation circuit 300C generates the cancellation signals according to the obtained transmitting signals.

The output terminal of the main delay line DL is coupled to the first branch circuit of the two first circuits A1 through the first power divider PD0. In the first circuit A1, the input terminal of the second power divider PDi of the i-th branch circuit (2≦i≦n, and “i” is an integer) is coupled to the second output terminal of the second power divider PD(i−1) of the (i−1)-th branch circuit. The output terminal of the second power combiner PCi of the i-th branch circuit is coupled to the second input terminal of the second power combiner PC(i−1) of the (i−1)-th branch circuit. The second output terminal of the second power divider PDn of the last stage (n-th) branch circuit is coupled to the input terminal of the first delay line DL1.

For example, in the third embodiment, the cancellation circuit 300C may comprise two first circuits A1, and each first circuit A1 may comprise four branch circuits. The first branch circuit of each first circuit A1 may comprise a second power divider PD1, a first unit DX, and a second power combiner PC1. The second branch circuit of each first circuit A1 may comprise a second power divider PD2, a first unit DX, and a second power combiner PC2. The input terminal of the second power divider PD1 of the first branch circuit is coupled to one output terminal of the first power divider PD0. The output terminal of the second power combiner PC1 is coupled to one input terminal of the first power combiner PC0. In the first circuit A1, the input terminal of the second power divider PD2 of the second branch circuit is coupled to the second output terminal of the second power divider PD1 of the first branch circuit. The output terminal of the second power combiner PC2 of the second branch circuit is coupled to the second input terminal of the second power combiner PC1 of the first branch circuit. The second output terminal of the second power divider PD4 of the last stage (the fourth) branch circuit of the first circuit A1 is coupled to the input terminal of the first delay line DL1.

In the second circuit A2, the m branch circuits (“m” is an integer) of the third circuit A3 are connected according to the circuit of FIG. 4. The m branch circuits are coupled to the fourth circuit. In the embodiment, the output terminal of the first delay line DL1 is coupled to the input terminal of the third power divider PD21. The output terminal of the third power combiner PC21 is coupled to the second input terminal of the second power combiner PC4. In the j-th branch circuit (2≦j≦m, and “j” is an integer) of the third circuit A3, the input terminal of the third power divider PD2j is coupled to the second output terminal of the third power divider PD2(j−1), and the output terminal of the third power combiner PC2j is coupled to the second input terminal of the third power combiner PC2(j−1). The second output terminal of the third power divider PD2m of the m-th branch circuit is coupled to the input terminal of the fourth power divider PD33. The second input terminal of the third power combiner PC2m of the m-th branch circuit is coupled to the output terminal of the fourth power combiner PC33.

For example, in the third embodiment, the second circuit A2 may comprise two third circuits A3. The third circuits A3 each comprise two branch circuits. The first branch circuit of the third circuit A3 may comprise a third power divider PD21, a second unit DY, and a third power combiner PC21. The second branch circuit of the third circuit A3 may comprise a third power divider PD22, a second unit DY, and a third power combiner PC22. The output terminal of the third power combiner PC21 is coupled to the second input terminal of the second power combiner PC4. In the second branch circuit (when j=2), the input terminal of the third power divider PD22 is coupled to the second output terminal of the third power divider PD21. The output terminal of the third power combiner PC22 is coupled to the second input terminal of the third power combiner PC21.

In the embodiments, the power dividers and the power combiners can be Wilkinson power dividers. Since the power dividers and the power combiners have predetermined insertion losses, the more power dividers or power combiners that are traversed, the larger is the resulting insertion loss of the cancellation signal, the amount of the cancellation signal is decreased. When the amount of the cancellation signal at the input of the second coupler CPL2 is too small, the interference cancellation is insufficient. Thus, the coupling coefficients of the first coupler CPL1 and the second coupler CPL2 are designed to be larger. Therefore, the amount of the cancellation signal at the input of the second coupler CPL2 will be large enough. In addition, the insertion loss at the main path where the first coupler CPL1 is located is decreased, improving the efficiency of the transmitter TX.

FIG. 9 illustrates a first unit DX and a second unit DY according to an embodiment of the disclosure. In the embodiment, the first unit DX and the second unit DY both comprise a second delay line DL2 and a digital step attenuator DSA. The second delay line DL2 and the digital step attenuator DSA are connected serially. The second delay line DL2 is controlled by the controller 400 to adjust the delay of the cancellation signals. The digital step attenuator DSA is also controlled by the controller 400 to adjust the attenuation of the cancellation signals. In the embodiment, the second delay line DL2 and the digital step attenuator DSA can be common adjustable components, such as programmable controlled delay lines and digital step attenuators. The description of their detailed structures is omitted here for sake of brevity.

FIG. 10 illustrates a circuit diagram of the matching circuit M1 according to an embodiment of the disclosure. In the embodiment, the matching circuit M1 may comprise a first capacitor C1, a second capacitor C2, a first inductor L1, a second inductor L2, and a varactor diode D1. One terminal of the first capacitor C1 is the first input of the matching circuit M1, the other terminal of the first capacitor C1 is coupled to the terminals of the second capacitor C2 and the first inductor L1. Another terminal of the second capacitor C2 is the output of the matching circuit M1. Another terminal of the first inductor L1 is coupled to the cathode of the varactor diode D1 and one terminal of the second inductor L2. The anode of the varactor diode D1 is grounded, and another terminal of the second inductor L2 is the second input of the matching circuit M1. The first input of the matching circuit M1 is coupled to the third coupler CPL3, the second input of the matching circuit M1 is coupled to the controller 400, and the output of the matching circuit M1 is coupled to the antenna 200. In an embodiment, the first inductor L1 can be a conductive wire with a predetermined length. In a high frequency environment, the conductive wire functions as an inductor. The second inductor L2 can be a high frequency choking coil, which allows the second input terminal to receive the input voltage but restrains the high frequency signal leaking from the second input terminal. During operation, the forward power detector FWD and the reverse power detector REV detect the transmission power of the transceiver circuit 100, and the reversing power reflected from the antenna 200. The controller 400 obtains the transmission power and the reversing power, and adjusts the input voltage of the second input terminal to control the forward and reverse capacitances of the varactor diode D1. Therefore, the impedances between the transceiver circuit 100 and the antenna 200 are matched, and interference from the reflected signals of the antenna 200 to the receiver RX is decreased.

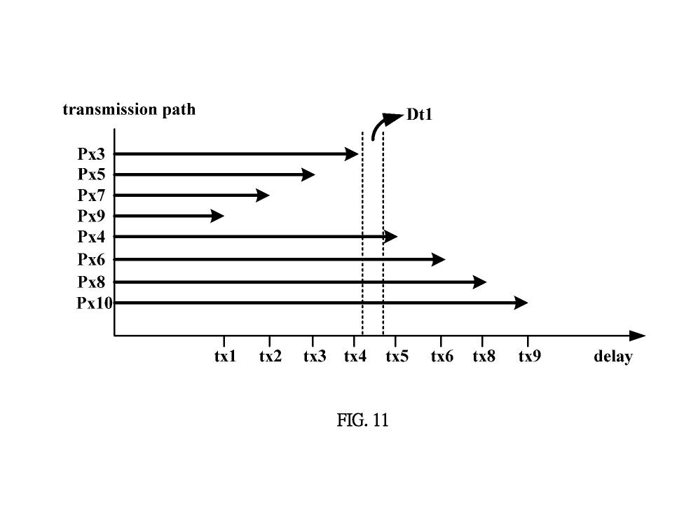

FIG. 11 illustrates the delay of branch circuits of the cancellation circuit 300 according to an embodiment of the disclosure. In FIG. 11, the transmission path Px3 indicates the delay from the signal input to the input terminal of the cancellation circuit 300 to the output terminal of the cancellation circuit 300 through the branch circuit P3. Similarly, the transmission paths Px4-Px10 indicate the delays to the signals passing through the branch circuits P4-P10. In FIG. 11, the region Dt1 between the dotted lines represents the possible delay of the leakage signal from the transmitter TX of FIG. 1 to the second coupler CPL2 through the circulator CIR. The controller 400 independently controls each first unit DX. In an embodiment, the controller 400 independently controls the delay of the second delay line DL2 and the attenuation of the digital step attenuator DSA to impart different delays and amplitudes to the signals passing through each branch circuit of the cancellation circuit 300. Since the signals of each branch circuit are combined by the power combiner, signals with different delays and amplitudes are combined to generate cancellation signal with the same delays and amplitudes as the leakage signal. Thus, interference caused by the leakage signal to the receiving signal is decreased, increasing the receiving capability of the receiver RX.

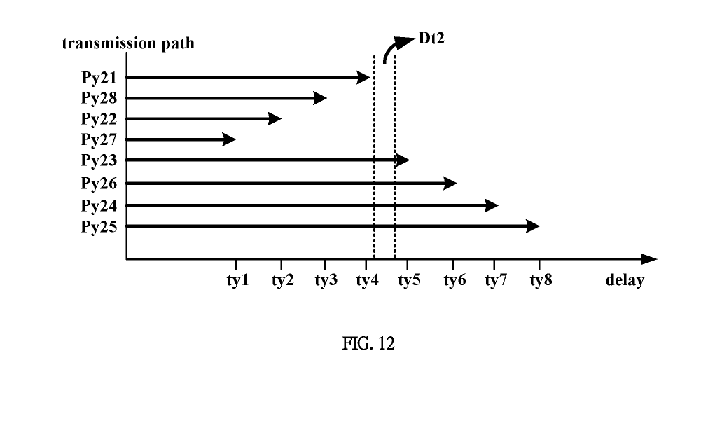

FIG. 12 illustrates the delay of branch circuits of the cancellation circuit 300 according to another embodiment of the disclosure. In FIG. 12, the transmission path Py21 indicates the delay from the signal input to the input terminal of the cancellation circuit 300 to the output terminal of the cancellation circuit 300, through the branch circuit P21. Similarly, the transmission paths Py22-Py28 indicate the delays to the signals passing through the branch circuits P22-P28. In FIG. 11, the region Dt2 between the dotted lines represents the possible delay of the near-field interference signal from the antenna 200 of FIG. 1 to the second coupler CPL2 through the circulator CIR. The controller 400 independently controls each second unit DY. In an embodiment, the controller 400 independently controls the delay of the second delay line DL2 and the attenuation of the digital step attenuator DSA to impart different delays and amplitudes to the signals passing through each branch circuits of the cancellation circuit 300. Since the signals of each branch circuits are combined by the power combiner, the signals with different delays and amplitudes are combined to generate cancellation signal with the same delays and amplitudes as the near-field interference signal. Thus, interference from the near-field interference signal caused to the receiving signal is decreased, increasing the receiving capability of the receiver RX.

The transceiver circuits for suppressing interference signals according to the embodiments of the disclosure minimize insertion losses of the cancellation signal. Referring to FIGS. 7-9 and 11-12, in the transmission paths Px3-Px10 of the cancellation circuit 300, the controller 400 controls the attenuation of the first units DX of the transmission paths P3-P10, to enlarge the signal by passing it through fewer power dividers. Thus, the distribution of the signals in the transmission paths P3-P10 conforms with Sampling Theory, achieving the goal of canceling the leakage signal with larger energy. In the transmission paths Py21-Py28 of the cancellation circuit 300, the controller 400 controls the attenuation of the second units DY of the transmission paths P21-P28, to enlarge the signal by passing it through fewer power dividers. Thus, the distribution of the signals in the transmission paths P21-P28 also conforms with Sampling Theory, achieving the goal of canceling the near-field interference signal with larger energy.

The embodiments shown and described above are only examples. Many details are often found in the art such as the other features of signal filtering and power regulating. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A cancellation circuit, comprising:
a main delay line delaying a number of transmitting signals of a transmitter;
a first power divider having an input terminal coupled to the main delay line;
a first power combiner; and
a plurality of first circuits generating a plurality of the first cancellation signals for canceling a plurality of leakage signals according to the delayed transmitting signals, wherein:
the first circuit comprises n branch circuits,
a first branch circuit of the n branch circuits is coupled between the first power divider and the first power combiner,
a (k−1)-th branch circuit of the n branch circuits is coupled to a k-th branch circuit of the n branch circuits, where the parameter “k” is from 2 to n, and the parameters “k” and “n” are integer numbers, and
the first power combiner outputs the first cancellation signals generated by the first circuits.

2. The cancellation circuit of claim 1, further comprising:
a plurality of first delay lines coupled to the n-th branch circuit of the first circuit; and
a plurality of second circuits coupled to the first delay line and the n-th branch circuit of the first circuit, and generating a plurality of the second cancellation signals for canceling near-field interference signals, wherein the first power combiner further outputs the second cancellation signals generated by the second circuits.

3. The cancellation circuit of claim 2, wherein the branch circuit of the first circuit comprises:
a second power divider;
a first unit having a terminal coupled to a first output terminal of the second power divider and adjusting the delay and amplitude of the signal passing through the branch circuits of the first circuit; and
a second power combiner, wherein a first input terminal of the second power combiner is coupled to another terminal of the first unit.

4. The cancellation circuit of claim 3, wherein in the first circuit, a second output terminal of the second power divider of the (k−1)-th branch circuit is coupled to an input terminal of the second power divider of the k-th branch circuit, and a second input terminal of the second power combiner of the (k−1)-th branch circuit is coupled to an output terminal of the second power combiner of the k-th branch circuit.

5. The cancellation circuit of claim 3, wherein a second output terminal of the second power divider of the n-th branch circuit is coupled to the first delay line.

6. The cancellation circuit of claim 3, wherein the first unit comprises:
a second delay line adjusting the delay of the cancellation signal; and
an attenuator connected to the second delay line in serial and adjusting the attenuation of the cancellation signal.

7. The cancellation circuit of claim 2, wherein the second unit comprises:
a third circuit comprising m branch circuits, wherein the h-th branch circuit of the m branch circuits is coupled to the (h−1)-th branch circuit, where the parameter “h” is from 2 to m, and the parameters “h” and “m” are integer numbers; and
a fourth circuit coupled to the m branch circuits of the third circuit.

8. The cancellation circuit of claim 7, wherein the branch circuit of the third circuit comprises:
a third power divider;
a second unit having a terminal coupled to the first output terminal of the third power divider and adjusting the delay and amplitude of the signal passing through the branch circuits of the third circuit; and
a third power combiner, wherein a first input terminal of the third power combiner is coupled to another terminal of the second unit.

9. The cancellation circuit of claim 8, wherein the fourth circuit comprises:
a fourth power divider;
two of the second units, wherein terminals of the second units are respectively coupled to output terminals of the fourth power divider to adjust the delay and amplitude of the signal passing through the fourth circuit; and
a fourth power combiner, wherein two input terminals of the fourth power combiner are respectively coupled to another terminals of the second units.

10. The cancellation circuit of claim 9, wherein in the third circuit, a second output terminal of the third power divider of the (h−1)-th branch circuit is coupled to an input terminal of the third power divider of the h-th branch circuit, a second input terminal of the third power combiner of the (h−1)-th branch circuit is coupled to an output terminal of the third power combiner of the h-th branch circuit, a second output terminal of the third power divider of the m-th branch circuit is coupled to an input terminal of the fourth power divider, and a second input terminal of the third power combiner of the m-th branch circuit is coupled to an output terminal of the fourth power combiner.

11. The cancellation circuit of claim 8, wherein the second unit comprises:
a second delay line adjusting the delay of the cancellation signal; and
an attenuator connected to the second delay line in serial and adjusting the attenuation of the cancellation signal.

12. A transceiver circuit, comprising:
a transmitter;
a receiver;
an antenna;
a circulator;
a first coupler coupled between the transmitter and the circulator;
a first amplifier coupled between the transmitter and the first coupler, and amplifying transmitting signals;
a second coupler coupled between the receiver and the circulator;
a second amplifier coupled between the receiver and the second coupler, and amplifying receiving signals;
a third coupler coupled between the antenna and the circulator, wherein the first coupler, the second coupler and the third coupler are coupled to the circulator to match impendences of an input and an output of the circulator;
the cancellation circuit of claim 1 coupled between the first coupler and the second coupler, receiving the part of the transmitting signals from the first coupler, and generating the first cancellation signals and the second cancellation signals; and
a third amplifier coupled between the cancellation circuit and the second coupler, receiving and amplifying the first cancellation signals and the second cancellation signals, and outputting the amplified first cancellation signals and the amplified second cancellation signals to the second coupler to increase coupling coefficients of the first cancellation signals and the second cancellation signals.

13. The transceiver circuit of claim 12, further comprising:
a forward power detector coupled to the third coupler to obtain a transmission power of the transceiver circuit;
a reverse power detector coupled to the third coupler to obtain a reverse power reflected from the antenna;
a matching circuit coupled to the third coupler to match impendence of the transceiver circuit; and
a controller coupled to the forward power detector, the reverse power detector and the matching circuit, and adjusting an input voltage of the matching circuit to match the impendence of the transceiver circuit.

14. The transceiver circuit of claim 13, wherein the matching circuit comprises:
a first capacitor, wherein one terminal of the first capacitor is being as a first input terminal of the matching circuit and is coupled to the third coupler;
a second capacitor, wherein one terminal of the second capacitor is coupled to another terminal of the first capacitor, and another terminal of the second capacitor is being as an output terminal of the matching circuit and is coupled to the antenna;
a first inductor, wherein a terminal of the first inductor is coupled to another terminal of the first capacitor;
a second inductor, wherein one terminal of the second inductor is being as a second input terminal of the matching circuit and is coupled to the controller; and
a varactor diode having a grounded anode and a cathode coupled to another terminal of the first inductor and another terminal of the second inductor.

15. The transceiver circuit of claim 12, further comprising:
a plurality of first delay lines coupled to the n-th branch circuit of the first circuit; and
a plurality of second circuits coupled to the first delay line and the n-th branch circuit of the first circuit, and generating a plurality of the second cancellation signals for canceling near-field interference signals, wherein the first power combiner further outputs the second cancellation signals generated by the second circuits,
wherein the branch circuit of the first circuit comprises:
a second power divider;
a first unit having a terminal coupled to a first output terminal of the second power divider and adjusting the delay and amplitude of the signal passing through the branch circuits of the first circuit; and
a second power combiner, wherein a first input terminal of the second power combiner is coupled to another terminal of the first unit.

16. The transceiver circuit of claim 15, wherein:
in the first circuit, a second output terminal of the second power divider of the (k−1)-th branch circuit is coupled to an input terminal of the second power divider of the k-th branch circuit, and a second input terminal of the second power combiner of the (k−1)-th branch circuit is coupled to an output terminal of the second power combiner of the k-th branch circuit;
a second output terminal of the second power divider of the n-th branch circuit is coupled to the first delay line; and
the first unit comprises:
a second delay line adjusting the delay of the cancellation signal; and
an attenuator connected to the second delay line in serial and adjusting the attenuation of the cancellation signal.

17. The transceiver circuit of claim 15, wherein the second unit comprises:
a third circuit comprising m branch circuits, wherein the h-th branch circuit of the m branch circuits is coupled to the (h−1)-th branch circuit, where the parameter “h” is from 2 to m, and the parameters “h” and “m” are integer numbers; and
a fourth circuit coupled to the m branch circuits of the third circuit.

18. The transceiver circuit of claim 17, wherein:
the branch circuit of the third circuit comprises:
a third power divider;
a second unit having a terminal coupled to the first output terminal of the third power divider and adjusting the delay and amplitude of the signal passing through the branch circuits of the third circuit; and
a third power combiner, wherein a first input terminal of the third power combiner is coupled to another terminal of the second unit; and
the fourth circuit comprises:
a fourth power divider;
two of the second units, wherein terminals of the second units are respectively coupled to output terminals of the fourth power divider to adjust the delay and amplitude of the signal passing through the fourth circuit; and
a fourth power combiner, wherein two input terminals of the fourth power combiner are respectively coupled to another terminals of the second units.

19. The transceiver circuit of claim 18, wherein in the third circuit, a second output terminal of the third power divider of the (h−1)-th branch circuit is coupled to an input terminal of the third power divider of the h-th branch circuit, a second input terminal of the third power combiner of the (h−1)-th branch circuit is coupled to an output terminal of the third power combiner of the h-th branch circuit, a second output terminal of the third power divider of the m-th branch circuit is coupled to an input terminal of the fourth power divider, and a second input terminal of the third power combiner of the m-th branch circuit is coupled to an output terminal of the fourth power combiner.

20. The transceiver circuit of claim 18, wherein the second unit comprises:
a second delay line adjusting the delay of the cancellation signal; and
an attenuator connected to the second delay line in serial and adjusting the attenuation of the cancellation signal.
